(19) United States
(12) Patent Application Publication
(10) Pub. No.: US 2008/0292051 A1
(43) Pub. Date: Nov. 27, 2008

(54) IMAGING DEVICE

(76) Inventors: Thomas Dippl, Pressath (DE); Gerhard Friedrich, Altenstadt an der Waldnaab (DE); Ute Friedrich, Altenstadt an der Waldnaab (DE); Peter Gmeiner, Schwabach (DE); Claus-Gunter Schliermann, Kemnath (DE); Elisabeth Friedrich, Altenstadt an der Waldnaab (DE)

Correspondence Address: BRINKS HOFER GILSON & LIONE, P.O. BOX 10395, CHICAGO, IL, 60610, US

(21) Appl. No.: 12/105,711

(22) Filed: Apr. 18, 2008

(30) Foreign Application Priority Data
Apr. 27, 2007 (DE) DE 102007020014.7

(51) Int. Cl. H05G 1/32; G01N 23/04

(52) U.S. Cl. 378/62; 378/97

(57) ABSTRACT

An imaging device with a radiographic source and with at least one image receiver, with an imaging detector able to be assigned to the image receiver or to each image receiver and with the image receiver or each image receiver including a sensor for registration of the imaging detector, with a signal output of the sensor being connected directly in a circuit to a signal input of the radiographic source.

This patent document claims the benefit of DE 10 2007 020 014.7 filed on Apr. 27, 2007, which is hereby incorporated by reference.

### BACKGROUND

The present embodiments relate to an imaging device with a radiographic source and at least one image receiver, with an imaging detector being able to be assigned to the at least one image receiver.

An imaging device may be used as a medical x-ray device with an x-ray source. The image receiver may record x-ray images of a patient to be examined. The image receiver may be a cassette drawer. The imaging device may include a particle radiation source.

To create a recorded image, an imaging detector is inserted into the corresponding image receiver and the x-ray source is aligned with the image receiver.

It may not be apparent from outside whether an imaging detector is inserted into the image receiver or not. The radiographic source, for example, the x-ray source, may be switched on although no imaging detector is inserted in the corresponding image receiver. The radiation dose administered causes unnecessary stress to the patient receiving the radiation treatment, since without the imaging detector no recorded image can be created, and the recording is repeated.

An imaging device may have a number of holders, for example, one holder for recording images of a patient lying down and another holder for recording images of a patient in a standing position. Each holder is as a rule assigned an image receiver, which frequently includes an exposure measuring chamber for automatic exposure time setting. The exposure measuring chamber measures the radiation dose reaching the image receiver and, when a predetermined dose limit value is reached, of triggering a switch-off signal for the x-ray source.

In addition to inserting the imaging detector, the exposure measurement chamber assigned to the imaging detector is activated by an operator. The choice and activation of the exposure measuring chamber may be made at a control console. Although, for example, an imaging detector is inserted in the correct image receiver, the exposure measuring chamber assigned to the imaging detector may not be activated by the operator. If an image recording with automatic exposure is triggered, the result is an unnecessary exposure of the patient to radiation. The exposure measurement chamber selected by mistake does not receive any radiation. If the selected exposure measurement chamber however does not receive any radiation dose, then it also does not create any switch-off signal for the radiographic source, since the dose limit value is not reached.

DE 200 13 478 U1 discloses a switching contact for a cassette holder with mobile anti-scatter grid in an x-ray device. The x-ray device is connected in series with a grid-coupled contact and is activated when the cassette is inserted. The x-ray source may be activated if both contacts have responded.

### SUMMARY AND DESCRIPTION

The present embodiments may obviate one or more of the drawbacks inherent in the related art. For example, in one embodiment, an imaging device may be safe to operate.

In one embodiment, an imaging device includes a radiographic source and at least one image receiver. An imaging detector may be assigned to the image receiver or to each image receiver. The image receiver(s) may include a sensor for registering the imaging detector. A signal output of the sensor may be connected in a circuit directly to a signal input of the radiographic source.

The imaging device may be a medical examination device, such as an x-ray device, for medical examination and for fluoroscopy of the body or of parts of the body of a patient.

The radiographic source may be a device for creating and emitting electromagnetic radiation or particle radiation, such as an x-ray radiation. For example, the radiographic source may be an x-ray tube that emits x-rays.

During a medical operation, the imaging device may radiate the body or parts of the body of a patient with radiation beams penetrating or at least partly penetrating the body or parts of the body of the patient.

The imaging detector may be a radiation detector and/or a film material. The imaging detector may be used to create an image depending on the intensity of the radiation hitting the imaging detector. The imaging detector may be a fluorescing screen or a light-sensitive film material, for example, an x-ray film cassette, or also a number of light-sensitive electronic sensors. The imaging detector may register the beams attenuated in their intensity by their passage through the body or part of the body of a patient. A projection, for example, an x-ray image, of the object under examination may be created using the imaging detector.

The image receiver(s) may be a cassette drawer. The imaging detector may be inserted, for example, reversibly. The image receiver(s) and the radiographic source may be aligned to one another or able to be oriented, such that an imaging detector inserted into the image receiver is illuminated by the radiation of the radiographic source. If an imaging device features a number of image receivers, one image receiver is usually selected for exposure.

The sensor for registration of the imaging detector is assigned to the image receiver or to each receiver and establishes (detects) whether the imaging detector is inserted into the respective image receiver. For example, in the case of a cassette drawer, the sensor may detect whether the imaging detector and/or the film cassette is inserted into the cassette drawer. The sensor may be an electronic sensor, for example, an optical or as a tactile sensor. Alternatively, the sensor may be a switch contact. If an imaging detector is in the corresponding image receiver, the sensor creates a detector recognition signal, which is indicative of the presence of an imaging detector, for example, for the presence of an x-ray film cassette in a cassette drawer.

The sensor for registration of the imaging detector is connected directly in a circuit via a signal output to a signal input of the radiographic source. The detector recognition signal may be transmitted to the radiographic source to be undertaken independent of the presence of a mobile anti-scatter grid. The detector recognition signal may also be transmitted if no grid or a static anti-scatter grid is present. The radiographic source may output radiation as a function of the presence of a detector recognition signal. Such a signal input enabling the generation of radiation as a rule features the corresponding x-ray source. Since the sensor is connected directly to the enabling input of the x-ray source, no central device controller is required.

During medical operation of the imaging device, the detector recognition signal may prevent the radiographic source from being aligned to an image receiver and being activated, although no imaging detector is assigned to the selected image receiver. The detector recognition signal may be used to prevent a patient to be examined from being subjected to unnecessary radiation.

The radiographic source, such as an x-ray source may include a standard signal input which is provided for an activation signal. The standard signal input may, for example, be the signal input for a door contact signal, which is present with x-ray devices to prevent the activation of the radiographic source unless the door to a control room is closed. Already installed x-ray devices using the standard signal input may be upgraded so that the unnecessary exposure to radiation because of the above-mentioned first operating error can be prevented.

The radiographic source may include a voltage creator, such as a high voltage creator, for example, a generator. The sensor for registering the imaging detector may be connected to a signal input of the voltage creator. A voltage for generating the radiation may be created by the voltage creator. Unnecessary irradiation of a patient may be suppressed directly without intermediate steps. For example, the voltage creator may be prevented from creating a voltage if no imaging detector is assigned to the selected image receiver.

The sensor may be connected to a signal input provided for an enabling signal of the voltage creator. The voltage creator may create (generate) a voltage as a function of a detector recognition signal having been received. For x-ray devices with a mobile anti-scatter grid or with a digital x-ray detector, a signal input for an enabling signal is generally present. Otherwise, a corresponding configuration of the voltage creator is sufficient in order to require the request for a detector recognition signal for enabling the creation of a voltage. Using the presence of signal inputs of the voltage creator, an unnecessary irradiation of a patient may be avoided in imaging devices.

In one embodiment, the image receiver or each image receiver may include an exposure measurement device for regulating the radiation. The exposure measurement device measures the radiation dose occurring at the imaging detector assigned to the illuminated image receiver. During irradiation of a patient, the person operating the imaging device from a control room can follow and regulate the irradiation of the patient on the basis of, for example, a signal of the exposure measurement device. The exposure measurement device may trigger a switch-off signal for the radiographic source.

A control unit may be connected to the radiographic source. The control unit may control the exposure time of the imaging detector as a function of a signal of the exposure measuring device. For example, if the radiation dose measured by the exposure measurement device reaches a predetermined dose limit value, the control unit may trigger a switch-off signal for the radiographic source. This type of automatic exposure system can for example make it possible with a medical x-ray device to obtain an image of high quality with a radiation dose for the patient which is as low as possible, since the irradiation is only undertaken until such time as the exposure of an x-ray film cassette for example has achieved the necessary density.

The radiographic source may be an x-ray source.

The image receiver may be a cassette drawer, with the imaging detector being provided as a film cassette, such as an x-ray film cassette. After a completed exposure of the film cassette, the illuminated imaging detector may be removed from the cassette drawer and replaced by an unexposed one.

In one embodiment, an image receiver including a sensor and an exposure measurement device is assigned to two holders (locations). The radiographic source may be able to be aligned to one holder. In this case for the imaging device in medical operation, for example, with a medical x-ray device, one holder is usually provided for the x-raying of a patient lying down and one for x-raying of a standing patient.

In one embodiment, to use the holder for the examination of a patient lying down, the radiographic source is aligned onto the image receiver provided for x-raying in the lying position. An imaging detector, for example, an x-ray film cassette, may be inserted into the image receiver. The image receiver for which the automatic exposure system is activated may be selected by choosing the exposure measurement device of the corresponding image receiver, which may be done via an external console.

If an imaging detector for the examination of a patient lying down has been inserted into an image receiver and the image receiver, which is intended for the x-raying of a patient standing up, the radiographic source may not be activated for x-raying since the radiographic source does not receive a detector recognition signal from the selected image receiver. Unnecessarily high exposure to radiation for the patient may be avoided. The mistakenly selected exposure measurement device does not receive any radiation and does not supply any switch-off signal for the radiographic source since the dose limit value is not reached.

### BRIEF DESCRIPTION OF THE DRAWINGS

FIG. 1 illustrates one embodiment of a medical x-ray device with two image receivers.

FIG. 2 illustrates one embodiment of an x-ray generator and two image receivers.

### DETAILED DESCRIPTION

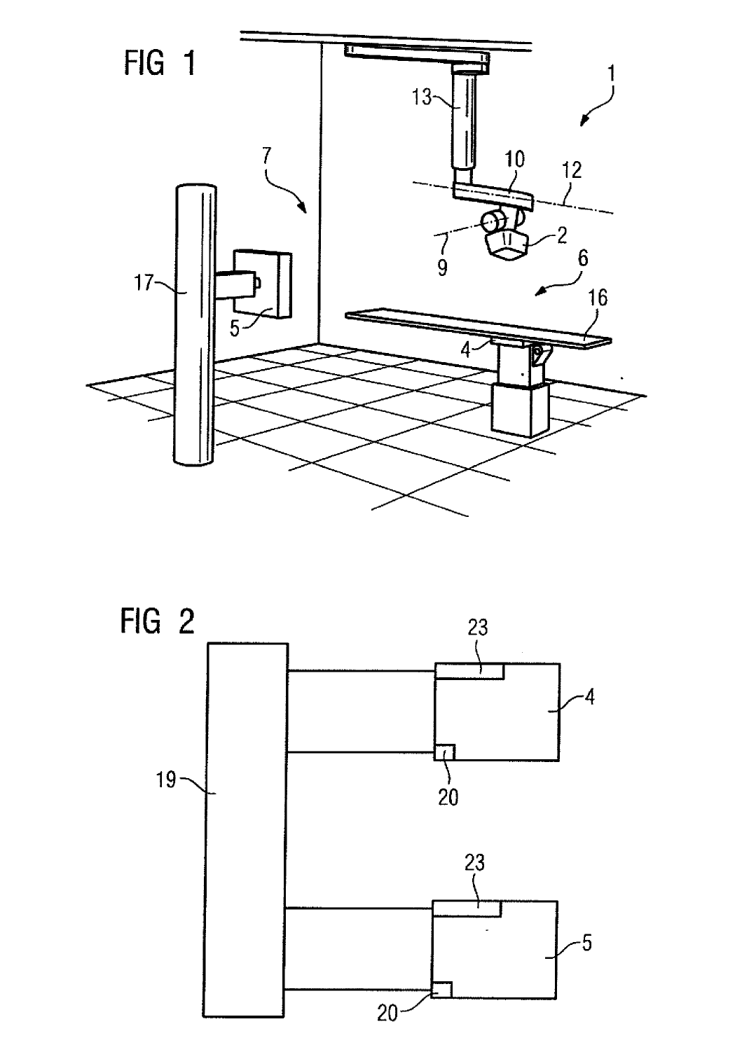

FIG. 1 shows a medical x-ray device (system) 1. The x-ray device 1 includes an x-ray source 2 and two image receivers 4, 5.

X-ray images of a patient may be recorded from two locations 6, 7. When a patient is lying down at location 6, the x-ray source 2 is aligned with the image receiver 4. When a patient is standing up at location 7, the x-ray source 2 is aligned with the image receiver 5.

The x-ray source 2 may be rotated around a horizontal axis 9 supported on an outrigger arm 10. The outrigger arm 10 is supported around a horizontal axis 12 and is rotatable on a ceiling stand 13. The ceiling stand 13 may be adjusted vertically, rotated, and/or moved horizontally. The x-ray source 2 is connected to an x-ray generator 19, which is shown in FIG. 2. The x-ray generator 19 supplies an x-ray voltage for creating the x-ray source.

The medical x-ray device 1 includes a patient bed 16. The image receiver 4 is arranged below the patient bed 16. The image receiver 4 may be a cassette drawer. For example, the image receiver 4 may be pulled out like a drawer under the patient bed 16 to allow an x-ray film cassette to be inserted or removed. For an examination of a patient lying on the patient bed 16, the x-ray source 2 is aligned on the image receiver 4.

The medical x-ray device 1 includes a floor stand 17 that carries an image receiver 5. The image receiver 5 is used for the creation of x-ray images of a patient standing up. The x-ray source 2 may be correspondingly aligned with the image receiver 5.

The image receivers 4, 5 include sensors 20 shown schematically in FIG. 2 for registration of the imaging detector, and an exposure measurement device 23 shown schematically in FIG. 2.

To create an x-ray image, a patient is positioned in a standing or lying position, respectively. An x-ray film cassette is inserted into the image receiver 5 for an examination in the lying position or into the receiver 4 for an examination in the standing position. The desired image receiver 4, 5 is activated by the respective exposure measurement device 23 being selected from a console. The x-ray source 2 is switched on and irradiates the patient with x-rays, which, after passing through the body of the patient, arrive attenuated at the x-ray film cassette and illuminate the cassette.

A first operating error can arise if the operator forgets to insert an x-ray film cassette in the image receivers 4, 5.

A second operating error can arise if the operator, for example does insert an x-ray film cassette in the correct image receiver 4 for an examination of a patient lying down, but then inadvertently activates the image receiver 5 which is intended for the examination of a patient standing up.

FIG. 2 shows an x-ray generator 19 and two image receivers 4, 5. The image receivers 4, 5 each include a sensor 20 for registration of the imaging detector and an exposure measurement device 23. The exposure measurement device 23 is included for controlling the radiation dose.

When an x-ray image is recorded, x-rays hit the exposure measurement device 23 of the corresponding image receiver 4, 5, which measures the x-ray dose arriving. If the measured x-ray dose reaches a predetermined dose limit value, a switch-off signal is triggered for the x-ray generator 19. The switch-off signal may cause the x-ray source 2 to be switched off. The radiation is performed until such time as the exposure of the x-ray film cassette has reached the necessary exposure. For example, slim patients may have a shorter exposure time than corpulent patients.

The signal output of the sensor 20 for registration of the imaging detector of each image receiver 4, 5 is connected in a circuit directly to a signal input for an enabling signal of the x-ray generator 19. The x-ray generator 19 requests an enabling signal at the signal input. An x-ray voltage may be created only if the enabling signal is present.

The sensor 20 does not generate a detector recognition signal for the image receivers 4, 5 when an x-ray film cassette is not present in the image receiver 4, 5. Accordingly, the x-ray generator 19 does not receive a detector recognition signal at its signal input for the enabling signal. The creation of an x-ray voltage is prevented, and the x-ray source 2 does not emit x-rays.

When an x-ray film cassette is inserted in the image receiver 4, for example, but the exposure measurement device 23 for the image receiver 5 is selected from the console and activate image receiver 5, the x-ray source 2 cannot be switched off by the operator. If the operator wishes to switch on the x-ray source 2 for an x-ray imaging system, the x-ray generator 19 requests an enabling signal from image receiver 5. Since an x-ray film cassette was not inserted into image receiver 5, but into image receiver 4, the x-ray generator 19 does not receive a signal from the sensor 20. The creation of an x-ray voltage is suppressed and the x-ray source 2 does not emit any x-rays.

1. An imaging device comprising:
a radiographic source that supplies radiation; and
an image receiver that receives the radiation, the image receiver including an imaging detector assigned to the image receiver,
wherein the imaging device includes a sensor for registration of the imaging detector, the sensor operable to generate a signal output of the sensor to a signal input of the radiographic source via a circuit.

2. The imaging device as claimed in claim 1, wherein the radiographic source includes a voltage generator, the sensor is connected to a signal input of the voltage generator.

3. The imaging device as claimed in claim 1, wherein the image receiver includes an exposure measurement device that regulates the radiation.

4. The imaging device as claimed in claim 3, wherein a control unit is connected to the radiographic source, the control unit is operable to control the exposure time of the imaging detector depending on a signal of the exposure measurement device.

5. The imaging device as claimed in claim 1, wherein the radiographic source includes an x-ray source.

6. The imaging device as claimed in claim 1, wherein the image receiver includes a cassette drawer with the imaging detector being provided as a film cassette.

7. The imaging device as claimed in claim 3, comprising a first location and a second location, wherein the image receiver is assigned, the radiographic source being able to be aligned with the first and second locations.

8. The imaging device as claimed in claim 5, wherein the imaging detector is an x-ray film cassette.

9. The imaging device as claimed in claim 2, wherein the radiographic source includes an x-ray source.

10. The imaging device as claimed in claim 2, wherein the image receiver includes a cassette drawer with the imaging detector being provided as a film cassette.

11. The imaging device as claimed in claim 3, wherein the radiographic source includes an x-ray source.

12. The imaging device as claimed in claim 3, wherein the image receiver includes a cassette drawer with the imaging detector being provided as a film cassette.

13. The imaging device as claimed in claim 4, wherein the radiographic source includes an x-ray source.

14. The imaging device as claimed in claim 4, wherein the image receiver includes a cassette drawer with the imaging detector being provided as a film cassette.
